(19) United States
(12) Patent Application Publication
(10) Pub. No.: US 2018/0172132 A1
(43) Pub. Date: Jun. 21, 2018

(54) BELT WHEEL

(71) Applicant: Miba Sinter Austria GmbH, Laakirchen (AT)

(72) Inventors: Stefan KIRCHWEGER, Gschwandt (AT); Philipp Lucas FRUEHWIRTH, Kirchham (AT)

(73) Assignee: Miba Sinter Austria GmbH, Laakirchen (AT)

(21) Appl. No.: 15/840,101

(22) Filed: Dec. 13, 2017

(30) Foreign Application Priority Data
Dec. 19, 2016 (AT) A 51150/2016

(51) Int. Cl. F16H 55/12; F16H 55/17

(52) U.S. Cl. CPC F16H 55/12; F16H 55/171

(57) ABSTRACT

The invention relates to a belt wheel (1) with a main body (2), which has a hub (4), on which a rim (3) is arranged, wherein the rim (3) is formed by a separate component from the main body (2), which component is connected in a form-fitting and/or force-fitting manner to the main body (2) by at least one connecting element (8), wherein the connecting element (8) comprises a first and a second connecting element part (9, 10), one of which is formed on the hub (4) and one of which is formed on the rim (3). The first connecting element part (9) is designed to be cam-like and the second connecting element part (10) is formed by at least one recess (17).

The invention relates to a belt wheel with a main body, which comprises a hub, on which a rim is arranged, wherein the rim is formed by a separate component from the main body, which component is connected in a form-fitting and/or force-fitting manner to the main body by at least one connecting element, wherein the connecting element comprises a first and a second connecting element part, one of which is formed the hub and one of which is formed on the rim.

Furthermore, the invention relates to a loop drive comprising at least two belt wheels.

In addition, the invention relates to a method for the form-fitting and/or force-fitting connection of a rim to a main body of a belt wheel, wherein on the main body of the belt wheel a hub is formed, onto which the rim is fitted, and the rim is connected to the main body by at least one connecting element, wherein the connecting element is formed by a first connecting element part and a second connecting element part, one of which is formed on the hub and one of which is formed on the rim.

Belt wheels are known to be used in loop drives for transmitting torque from one shaft to another shaft. For this between at least two belt wheels, one of which is arranged respectively on one of the shaft, a tensioning means, i.e. a belt is stretched. The driven belt wheel transmits the torque by means of the tensioning means to the non-driven belt wheel. To prevent the tensioning means migrating during operation from the belt wheel, often a so-called rim is used which protrudes over the running track of the tensioning means in radial direction. If the rim is not designed in one piece with the main body it has to be joined to the main body. Often the rim is welded to the main body at least in some points. This process requires a separate production step which cannot be integrated or can only be integrated with great difficulty into a production line of series or mass production. The manufacturing costs for the belt wheel are increased in this way.

In the prior art other methods for joining a rim to the main body of a belt wheel are described, which enable the simple, inexpensive and variable production and assembly of the rim.

Thus for example DE10 2014 201 565 A1 describes a method for securing a rim disc to a belt drive in which the rim disc is pushed in axial direction onto a collar of a belt wheel and afterwards a section of the rim is rolled into a groove of the collar.

DE 10 2005 018 581 A1 describes a tooth belt disc with a rim disc secured to the latter which is designed as an essentially flat metal disc with an internal toothing and is pressed with the internal toothing onto the tooth belt disc.

From EP 2 128 496 A2 a tooth belt wheel for a tooth belt drive is known with a pot or bell-shaped main body and at least one rim disc which is designed as a separate part. Welding, as well as pressing and caulking are given as methods for connecting the rims to the main body.

Furthermore, it is known to fix rim discs by screwing or clipping. However, the effort of assembly in this case is considerable.

The objective of the invention is to provide a way of connecting a rim to a main body of a belt wheel.

The objective is achieved by the aforementioned belt wheel in that the first connecting element part is designed to be cam-like and the second connecting element part is formed by at least one recess.

Furthermore, the objective is achieved by the aforementioned loop drive, in which at least one of the belt wheels is designed according to the invention.

In addition, the objective is achieved by the aforementioned method, in which the first connecting element part is designed to be cam-like and the second connecting element part is formed as at least one recess, in that also the cam-like first connecting element part is pushed into the recess, and in that afterwards the rim is rotated in circumferential direction, so that between the cam-like first connecting element part and the second connecting element part the form-fitting and/or force-fitting connection is formed.

It is an advantage here that the connection of the rim to the main body of the belt wheel can be formed by simple movements, namely pushing the rim onto the hub of the main body and subsequently rotating the rim in circumferential direction. Thus this connection method can be more easily integrated into an existing production line for belt wheels, whereby the latter can be produced less expensively, as no additional manipulation of the belt wheel is necessary in which the belt wheel is moved from the production line to a welding area. The simple force-fitting and form-fitting connection between the main body and the rim can also be disconnected if necessary in that the rim is rotated in opposite circumferential direction. In this way the assembly and disassembly of the belt can be simplified. Furthermore, the at least one connecting element can be produced easily by means of sintering technology. Due to the possible plastic deformation of the cam-like first connecting element parts when rotating the rim, which is provided in particular in the simplest embodiment variant of the belt wheel, the force-fitting and/or form-fitting connection of the rim to the main body of the belt wheel can be improved.

According to one embodiment variant of the belt wheel it is possible for the second connecting element part to be formed by two adjacent recesses, wherein the form-fitting and/or force-fitting connection can be formed by only one of the two recesses and can be pushed by means of the second recess of the rim onto the hub. To form the connection the rim is rotated in circumferential direction, so that the cam-like connecting part for forming the form-fitting and/or force-fitting connection is moved into the second recess.

In this way it is possible to achieve a higher degree of security to prevent the unintentional detachment of the rim from the main body of the belt wheel. Once the connection has been formed over only one of the two recesses of the second connecting element part, the other recess remains free during the operation of the belt wheel. If the recess is in the form of an opening, the latter can also be used for oiling the belt wheel, whereby a corresponding additional use can be achieved with the belt wheel.

According to a preferred embodiment variant of the belt wheel it is possible that the second connecting element part has an at least approximately W-shaped cross-section, as viewed in axial direction. In this way the rotation of the rim can be simplified, in that the cam-like connecting element part can be moved more easily from one to the other recess part.

For the more simple sintered production of the main body and the rim, preferably the cam-like first connecting element part is formed on the hub of the main body and the additional connecting element part in the rim.

It is also possible that in a circumferential direction adjoining the connecting element at least one additional connecting element is formed which comprises a third and a fourth connecting element part and to which the rim is connected to the main body in a force-fitting manner. By means of the additional force-fitting connection the security of the connection between the main body of the belt wheel and the rim can be improved.

It is an advantage in this case if the third connecting element part is designed to be cam-like, as this geometry of the connecting element part simplifies the rotatability of the rim in circumferential direction.

The fourth connecting element part can be formed by an additional recess which extends in circumferential direction over a greater distance than a width of the third connecting element in the same direction. In this way on the one hand it is possible to produce an exclusively friction-locked connection between the rim and the main body of the belt wheel, whereby also the rotatability of the rim can be improved in circumferential direction. On the other hand by means of the different geometry of the fourth connecting element part compared to the second connecting element part the assembly of the rim can be simplified in that the incorrect fitting of the rim onto the hub of the main body of the belt wheel can be avoided more effectively. The second connecting element part can therefore also be used as an assembly aid for the correct adjustment of the rim on the hub.

To additionally improve these effects it is possible that the additional recess of the fourth connecting element part, as viewed in axial direction, has an at least approximately rectangular or trapezoidal cross-section.

To improve the friction-fitting connection of the rim with the main body of the belt wheel it is possible that on one side wall of the additional recess of the fourth connecting element part, between the latter and the first connecting element part of the first connecting element as viewed in circumferential direction the third connecting element part is arranged, a projection protruding into the additional recess is formed. During the rotation of the rim in circumferential direction said projection slides on a flank of the cam-like third connecting element until the force-fitting is achieved, wherein the latter is restricted due to the relatively small surface of the projection to a smaller area.

As described above with regard to the first connecting element, the third connecting element part can be formed on the hub of the main body and the fourth connecting element part in the rim for simplifying the sintered production of the rim and of the main body of the belt wheel.

Furthermore, it is possible that a portion of the first connecting element part is arranged overlapping an axial end face, whereby it is possible to achieve better axial securing, in that a frictional connection can be formed via the adjoining surfaces of the first connecting element part and the rim.

According to one embodiment variant of the method it is possible that in circumferential direction adjoining the connecting element at least one additional connecting element is designed with a third and a fourth connecting element part, wherein the third connecting element part can be designed to be cam-like and the fourth connecting element part can be designed in the form of a recess, and in that the rim is connected by the additional connecting element in a force-fitting manner to the main body of the belt wheel by rotating the rim in circumferential direction. For this additional connecting element reference is made to the description above.

For a better understanding of the invention the latter is explained in more detail with reference to the following Figures.

In a simplified, schematic representation:

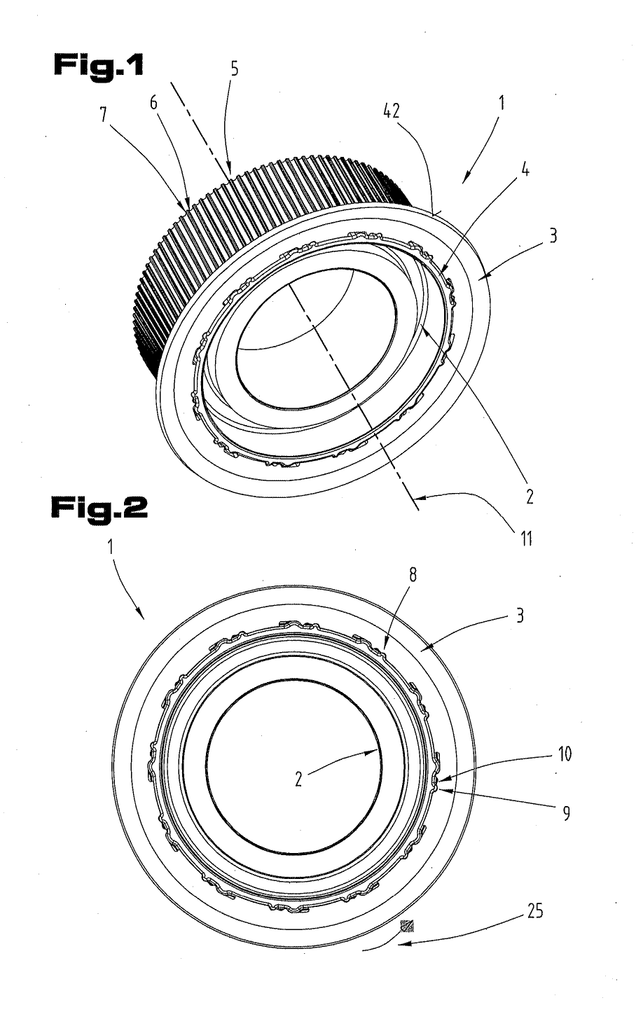

FIG. 1 is a belt wheel with a main body and rim in a non-connected state in perspective view;

FIG. 2 is the belt wheel according to FIG. 1 in the connected state and in side view;

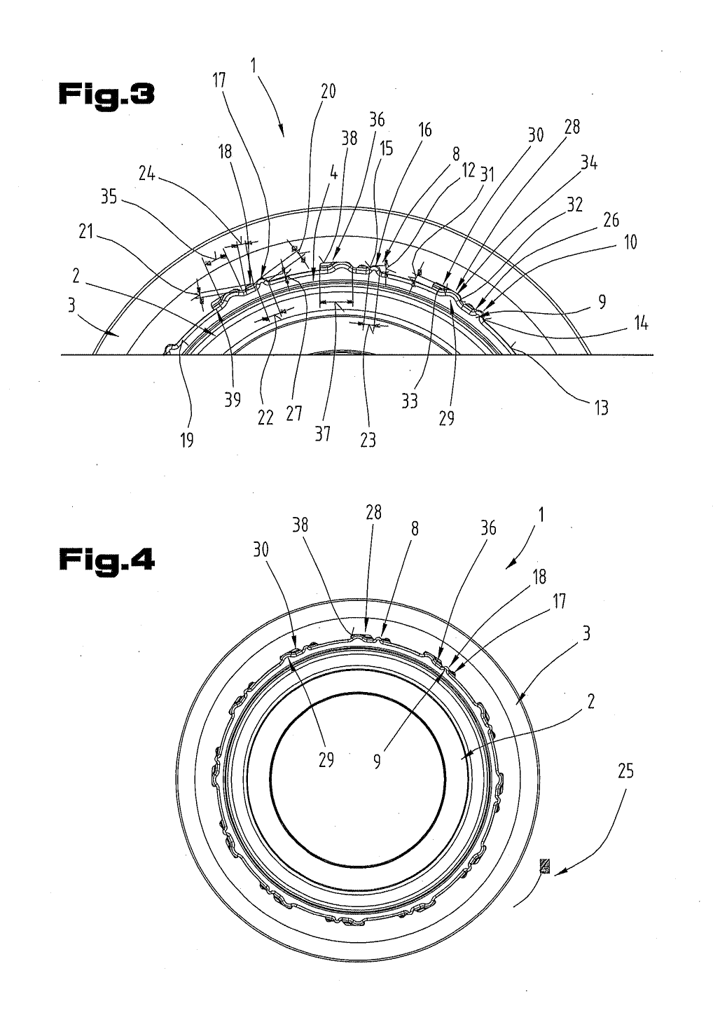

FIG. 3 is a cut-out of the belt wheel according to FIG. 1 in a non-connected state;

FIG. 4 is the belt wheel according to FIG. 1 in a connected state and in side view;

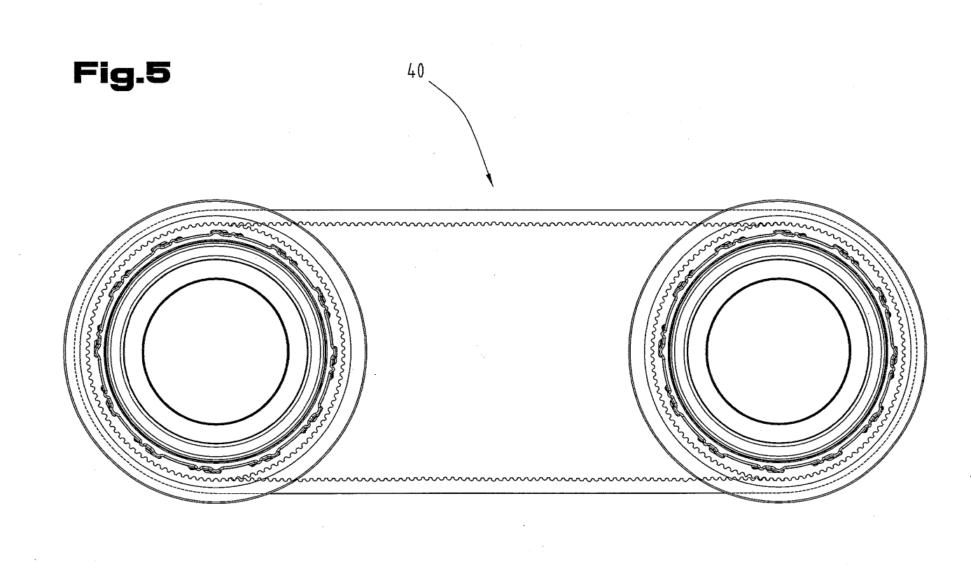

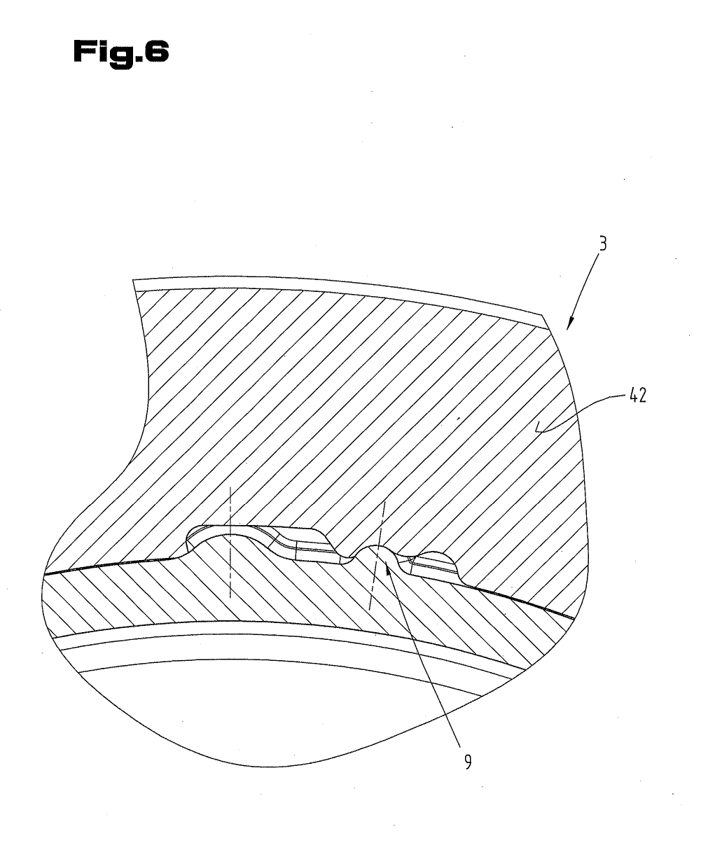

FIG. 5 is a belt drive in side view;

FIG. 6 is a cut-out of an embodiment variant of the belt wheel in axial view.

First of all, it should be noted that in the variously described exemplary embodiments the same parts have been given the same reference numerals and the same component names, whereby the disclosures contained throughout the entire description can be applied to the same parts with the same reference numerals and same component names. Also details relating to position used in the description, such as e.g. top, bottom, side etc. relate to the currently described and represented figure and in case of a change in position should be adjusted to the new position.

FIG. 1 shows a belt wheel 1 in the form of a tooth belt wheel shown in perspective view. Said tooth belt wheel 1 comprises a main body 2 and a rim 3 (thrust washer element), which is designed in this embodiment variant as a rim disc. The rim 3 is arranged laterally on an end side and on a hub 4 of the main body 2.

The wheel body 2 has a toothing 5 on a casing surface. Said toothing 6 is formed by teeth 6 with tooth gaps 7 in between. The geometry of the teeth 6 and the geometry of the tooth gaps 7 are designed so that engagement with a tooth belt can be achieved. As tooth belt wheels 1 are already known from the prior art with respect to the their geometric design, it is not necessary to discuss them further at this point and persons skilled in the art are therefore referred to the relevant literature.

The main body 2 and/or the rim 3 are preferably produced as sintered parts, wherein sintering comprises—as known—mixing a sintering powder possibly with various additives, such as lubricants, etc. to facilitate the removal of the sintered component from the mold, and also compacting the sintering powder in a pressing die into a green compact and sintering the green compact at a sintering temperature, which corresponds to the metal or metallic powder used. The sintering powders are usually metal or metallic powders for sintering alloys and can also be already prealloyed powders. After sintering if necessary a post compaction process and/or calibration is performed of the sintered component to increase the dimensional accuracy.

As sintering powders or sintering alloy powders for example a sintered iron or a sintered steel or powder can also be used according to standard SINT E 35, SINT E 36, SINT E 39, or also other sintering (alloy) powders known from the prior art.

Although the production of the belt wheel 1 by sintering is preferred, it is possible in principle to also make said belt wheel 1 by means of other production methods, for example by casting or injection molding techniques. However, sintering technology makes it possible to simplify the production of the belt wheel 1, so that if applicable no mechanical post-processing is necessary afterwards.

Although in the figures the belt wheel 1 is shown in the form of a tooth belt, the invention is not restricted to this. Rather the invention relates to belt wheels 1 themselves, for example also belt wheels with a smooth or roughened casing surface at least in the area of the belt track. Such belt wheels thus do not have any toothing in this area. Furthermore, the belt wheel 1 can also be provided in principle for a belt with a V-shaped cross-section or a rib belt, although it is not necessary to arrange the rim 3 to the same extent.

It should be noted at this point that the belt wheel 1 can also comprise an additional rim, which can be arranged on a second end face of the main body 2. The belt track on the casing surface can thus be delimited on both sides by a rim 3. For this additional rim the embodiments in this description can be applied, so that the latter and the main body 2 in this area can be designed as a described in the following.

The rim 3 is produced as a separate component so that it is necessary to connect the rim 3 to the main body 2 of the belt wheel 1. For this at least one connecting element 8 is provided, which is shown more clearly in FIG. 2 and in particular FIG. 3. Said Figures show the belt wheel 1 with a not yet connected rim 3.

As shown in these figures preferably a plurality of said connecting elements 8 are arranged around the circumference of the belt wheel 1, in particular distributed evenly. The exact number of connecting elements 8 depends on the diameter of the belt wheel 1 and the desired connection strength. Preferably, all of said connecting elements 8 are designed in the same way.

By means of the at least one connecting element 8 between the rim 3 and the main body 2 of the belt wheel 1 a force-fitting and/or form-fitting, in particular a force-fitting and form-fitting connection is produced. For this the connecting element 8 comprises a first connecting element part 9 and a second connecting element part 10.

The first connecting element part 9 is preferably arranged on the hub 4. The hub 4 is designed in the shown embodiment as an annular web, which is arranged on the end face of the main body 2 of the belt wheel 1 and projects over the latter in axial direction 11 (FIG. 1). Preferably, the hub 4 is arranged, as viewed in radial direction, below the belt track, i.e. the toothing 5 of the embodiment.

The first connecting element part 9 is designed as an at least approximately cam-like or nub-like projection, which projects over the hub 4 in radial direction. In particular, the first connecting element part 9 is designed to be cam-like.

The first connecting element part 9 has a maximum height 12. The height 12 is measured from a surface of the hub 4 up to the maximum dimension of the first connecting element part 9 in radial direction. Furthermore, the first connecting element part 9 has two side faces 14, 15 and a crown 16 or a cover surface between the two side faces 14, 15. In other words the first connecting element part 9 in the preferred embodiment variant can also be in the form of a tooth.

The first connecting element part 9 can also have a different shape than the cross-sectional form shown in the Figures (as viewed in axial direction 11). For example, the first connecting element part 9 can have a semi-circular or trapezoidal cross-sectional form, wherein round cross-sectional forms or cross-sectional forms with rounded edges are preferred.

Preferably, the first connecting element part 9 extends over the whole width of the hub 4 in axial direction 11.

The second connecting element part 10 is preferably formed on or in the rim 3. It is formed by two adjacent recesses 17, 18 in the rim 3. At least one of said recesses 17, 18 forms the contour of the first connecting element part 9 of the connecting element 8 at least partly, so that a form-fitting and possibly force-fitting connection is formed between the first connecting element part 9 and the second connecting element part 10, and thus a form-fitting and possibly force-fitting connection is formed of the rim 3 to the main body 2.

The other of the two recesses 17, 18 can also form the contour of the first connecting element part 9, in fact said recess 17 is designed to be larger in terms of its cross-section in axial direction 11 (FIG. 1) than the corresponding cross-section of the first connecting element part 9. Thus by means of said recess 17 there is no connection between the rim 3 and the main body 2 of the belt wheel 1. The cross-section of said recess 17 is dimensioned so that the rim 3 can be pushed onto the hub 4 of the main body 2. It is therefore possible that the recess 17 can also have a different cross-sectional form than the first connecting element part 9, in order to be able to perform its function. However, it is preferable, if also said recess 17 at least approximately forms the contour of the cross-section of the first connecting element part 9, as in this way the tilting of the rim 3 can be avoided more effectively when pushing onto the hub 4.

For the sake of completion, it should be noted that the recess 17, on pushing the rim 3 onto the hub 4 in FIG. 3 is the right of the two recesses 17, 18 of the second connecting element part 10. Said arrangement however only depends on the direction of rotation of the rim 3, with which it is connected to the main body 2 of the belt wheel. Thus also the reverse arrangement of the two recesses 17, 18 to one another is possible.

As in the shown embodiment variant the first connecting element part extends outwardly in radial direction, thus also the recesses 17, 18 extend outwardly in radial direction starting from an end face 19 of the rim 3 pointing to the hub 4.

A maximum depth 20 of the recess 17 for the axial fitting of the rim 3 onto the hub 4 is greater than the maximum height 12 of the first connecting element part 9 and is greater than a maximum depth 21 of the recess 18 for forming the form-fitting and possibly force-fitting connection between the rim 3 and the main body 2 of the belt wheel 1.

The maximum depth 21 of the recess 18 is slightly greater, of equal size or slightly smaller than the maximum height 12 of the first connecting element part 9. The term “slightly” means here that the dimension is such that the form-fitting connection is formed between the recess 18 and the first connecting element part 9.

Furthermore, the width 22 of the recess 17 is greater than the width 23 of the first connecting element part 9 and the width 24 of the recess 18. The width 24 of the recess 18 is slightly greater, of equal size or slightly smaller than the width 23 of the first connecting element part 9. Reference is made to the above definition of the term “slightly”.

The widths 22-24 are measured in the circumferential direction 25 (FIG. 2) of the rim 3.

The two recesses 17, 18 of the second connecting element parts 10 are preferably designed by the rim 3 as openings in axial direction 11 (FIG. 1). However, it is also possible for the recesses 17, 18 of the second connecting element part 10 to only be formed by depressions in the rim 3. In this case the recesses 17, 18 are formed on the surface of the rim 3 facing the belt track.

As explained above, the two recesses 17, 18 are designed to be next to one another in the rim 3 in circumferential direction 25 (FIG. 2). Here the two recesses 17, 18 are only separated from one another by a web 26. Said web 26 is preferably cam-like or tooth-shaped as viewed in axial direction 11 (FIG. 1) or is designed in the form of a wave crest, whereby sliding over the first connecting element part 9 out of recess 17 into recess 18 of the second connecting element part 10 is simplified. A maximum height 27 of this web 26 in radial direction is smaller than the maximum depth 20 of the recess 17 and smaller than the maximum depth 21 of the recess 18 of the second connecting element part 10.

The web 26 directly adjoins the recesses 17, 18 of the second connecting element part 10.

The web 26, like the first connecting element part 9, has two side faces, which pass into a crown or a cover surface. One of the two side faces respectively forms a delimitation for the recess 17 and the recess 18 of the second connecting element part 10. The side faces are designed to be inclined in radial direction, as shown in FIGS. 2 and 3. The gradient of said side faces is preferably smaller than the gradient of the side faces 14, 15 of the first connecting element part 9. This embodiment can be used in particular when the rim 3 is meant to be detached from the main body 2 of the belt wheel 1. If the rim 3 is meant to be non-detachable from the main body 2 of the belt wheel 1, it is also possible that the side face of the web 26 facing the recess 18 of the second connecting element part 10 has a greater inclination than the side face 14 of the first connecting element part 9. The steepness of the respective surfaces is viewed in terms of the inclination in radial direction. In other words, the side faces 14, 15 of the first connecting element parts 9 can have a smaller angle relative to the radial direction than the side faces of the web 26.

It is also possible for an axial stop for the rim 3 to be formed between the belt track of the belt wheel 1 and the rim 3, which ensures that the rim 3 can only be pushed up to this axial stop on the hub 4 of the main body 2 of the belt wheel 1. The axial stop can be designed as an additional annular web, which projects over the hub 3 in radial direction. However, it is also possible to form only some parts of an annular web extending over 360°.

According to a preferred embodiment variant of the belt wheel 1 it is possible that the second connecting element part 10 has the contour of an at least approximately W-shaped cross-section, as viewed in axial direction 11 (FIG. 1), resulting from the sequence of the recess 17, the web 26 and the recess 18 in circumferential direction 25 (FIG. 2).

It is also possible that in circumferential direction 25 (FIG. 2) adjoining the connecting element 8 at least one additional connecting element 28 is formed, which comprises a third and a fourth connecting element part 29, 30 and to which the rim 3 is connected in a force-fitting manner to the main body 2 of the belt wheel 1.

Preferably, a plurality of additional connecting elements 28 are distributed around the circumference of the belt wheel 1, in particular distributed evenly. It is also preferable if in circumferential direction 25 (FIG. 2) first and second connecting elements 8, 28 are arranged alternately, and in particular distributed evenly around the circumference.

The number of additional connecting elements 28 depends in particular on the number of connecting elements 8, wherein preferably the same number of connecting elements 8 and additional connecting elements 28 are arranged or formed.

Preferably, the third connecting element part 29 is arranged or formed on the hub 4. It is also preferred that the fourth connecting element part 30 is arranged or formed on the rim 3.

Although it is not preferred a reverse arrangement is also possible in that the third connecting element part 29 is formed on the rim 3 and the fourth connecting element part 30 is formed on the hub 4. The same also applies to the first connecting element part 9 and the second connecting element part 10 of the first connecting element 8.

Furthermore, a mixed arrangement is also possible, in that a portion of the first connecting element parts 9 and/or a portion of the third connecting element parts 29 are formed on the hub 4 and the remainder are formed on the rim 3. Thus a portion of the second connecting element parts 10 and/or the fourth connecting element parts 30 are arranged on the rim 3 and the remainder on the hub 4.

The third connecting element part 29 is designed to be at least approximately a cam-like or nub-like projection, which projects over the hub 4 in radial direction. In particular, the third connecting element part 29 is designed to be cam-like.

The third connecting element part 29 has a maximum height 31. The height 31 is measured from a surface of the hub 4 up to the maximum dimension of the third connecting element part 29 in radial direction. Furthermore, the third connecting element part 29 has two side faces 32, 33 and a crown 34 or a cover surface between the two side faces 32, 33. In other words, the third connecting element part 29 can also be in the form of a tooth in the preferred embodiment variant.

The third connecting element part 29 can however have a different cross-sectional form than the one shown in the Figures (as viewed in axial direction 11, FIG. 1). For example, the third connecting element part 29 can have a semi-circular or trapezoidal cross-sectional form, wherein round cross-sectional forms or cross-sectional forms with rounded edges are preferred.

Preferably, the third connecting element part 29 extends over the whole width of the hub 4 in axial direction 11.

It is also preferable if the third connecting element part 29 as viewed in circumferential direction 25 (FIG. 2) has a greater maximum width 35 than the first connecting element part 9.

The fourth connecting element part 30 is formed by an additional recess 36 which extends in circumferential direction 25 (FIG. 2) over a greater length 37 than the width 35 of the third connecting element 29 as viewed in the same direction. The length 37 of the recess 36 is at least large enough that with the rotation of the rim 3 in circumferential direction 25 the first connecting element part 9 of the first connecting element 8 can be moved from the recess 17 into the recess 18 of the second connecting element part 10.

Preferably, the additional recess 36 of the fourth connecting element part 30 as viewed in axial direction 11 (FIG. 1) has an at least approximately rectangular or trapezoidal cross-section. However, also other cross-sectional forms of the fourth connecting element part 30 are possible.

The fourth connecting element part 30 is formed in particular by only a single additional recess 36.

It is also preferable, if only a force-fitting connection is formed between the third connecting element part 29 and the fourth connecting element part 30.

The additional recess 36 of the fourth connecting element part 30 is preferably designed as an opening in axial direction 11 (FIG. 1) in the rim 3. However, it is also possible that the additional recesses 36 of the fourth connecting element part 30 is formed solely by depressions in the rim 3. In this case the additional recesses 30 are formed on the surface of the rim 3 facing the belt track.

According to a further embodiment variant of the belt wheel 1 it is possible that on a side wall 38 of the additional recess 36 of the fourth connecting element part 30, between the latter and the first connecting element part 9 of the first connecting element 8 as viewed in circumferential direction the third connecting element part 29 is arranged, a projection 39 is formed projecting into the additional recess. Said projection 39 can thereby be formed by an inclination of the side wall 38 of the additional recess 36 to form an undercut in the additional recess 36. In particular, said projection 39 is located at the transition between the end face 19 of the rim 3 pointing to the hub 4 with the side wall 38 of the recess. It is also preferred, if said projection 39 is designed in cross-section to be at least approximately thorn-like or at least approximately pointed (as viewed in the direction of the axial direction 11 FIG. 1). The point can also have a rounded end.

As already mentioned above, FIGS. 2 and 3 show the belt wheel 1 in a position in which the rim 3 is already placed or pushed onto the hub 4 of the main body 2, but there is not yet any connection between the rim 3 and the main body 2.

FIG. 4 shows the rim 3 connected to the main body 2 of the belt wheel 1.

To form the connection of the form-fitting and/or force-fitting connection of the rim 3 to a main body 2 of the belt wheel 1 the rim 3 is pushed onto the hub 4. Here the first connecting element part 9 of the first connecting element 8 is pushed into the recess 17 of the second connecting element 8, as shown in FIG. 2 or 3. Afterwards the rim 3 is rotated in circumferential direction 25, so that the (cam-like) connecting element part 9 of the first connecting element 8 is moved into the second recess 18 to form the form-fitting and/or force-fitting connection, as shown in FIG. 4.

If the second connecting element 28 is provided, the third connecting element part 29 inside the additional recess 36 of the fourth connecting element part 30 is moved in the direction of the side wall 38 of the additional recess 36, until the (cam-like) third connecting element part 29 bears against said side wall 38 and a force-fitting connection is formed between the side wall 38 and the third connecting element part 29. It is thus possible, particularly if the projection 39 is formed on the side wall 38, that between the side wall 38 (or the projection 39) and the third connecting element part 29 a form-fitting connection is also formed, in case the adjoining part of the side wall (in particular the projection 39) pushes into the third connecting element part 29.

In all of the embodiment variants of the belt wheel 1 the areas of the connecting element 1, which form the form-fitting and force-fitting connection between the rim 3 and the main body 2 of the belt wheel 1, are arranged above one another as viewed in radial direction. The same applies to the areas of the also provided additional connecting element 28, which form the force-fitting (and possibly form-fitting) connection.

For the sake of completion FIG. 5 shows a simple loop drive 40, in particular a belt drive. The latter comprises at least two belt wheels, between which and looping around the belt wheel a tensioning means 41, i.e. a belt, is stretched. At least one of said belt wheels is formed by the belt wheel 1 according to the invention. However, also both belt wheels can be formed respectively by a belt wheel 1 according to the invention. It is also possible that the loop drive 40 has more than two belt wheels, wherein at least one of said additional belt wheels is formed by a belt wheel 1 according to the invention.

In the simplest embodiment variant of the belt wheel 1 it is possible that the first connecting element 8 comprises the cam-like first connecting element part 9 and as a second connecting element part 10 only has one recess 17. In this embodiment variant by rotating the rim 3 in circumferential direction 25, as in the other embodiment variants, the first connecting element part 9 is applied against a radially lower end face of the recess 17. By further rotating the rim 3 there is an at least partly plastic deformation of the first connecting element part 9. In this way the first connecting element part 9 can be applied more effectively to the radially inner end face of the recess 17, whereby also the force-fitting and/or form-fitting connection is formed. The recess 17 according to one embodiment variant can have an at least approximately trapezoidal cross-section so that the first connecting element part 9 runs onto the said end face.

According to an additional embodiment shown in FIG. 6 it is possible that when connecting the rim 3 only a portion of the first connecting element parts 9 is deformed plastically. The remaining part of the first connecting element part 9 can then be arranged overlapping an axial end face 42 of the rim 3. It is thus possible that the first connecting element part 9 is not arranged as in the aforementioned embodiment fully in radial direction below the radial inner end face of the recess, but a portion of the first connecting element part 9 is arranged offset in axial direction relative to said end face. However, it should be noted that this can also be provided in all other embodiment variants of the belt wheel 1.

Furthermore, in all of the additional embodiment variants of the belt wheel 1 the first connecting element part 9 can be at least partly plastically deformed during the formation of the force-fitting and/or form-fitting connection between the rim 3 and the main body 2 of the belt wheel 1, in particular can be plastically deformed permanently.

The embodiments show or describe possible embodiment variants of the belt wheel 1, whereby it should be noted at this point that combinations of the individual embodiment variants are also possible.

Lastly, as a point of formality, it should be noted that for a better understanding of the structure of the belt wheel 1 the latter has not necessarily been illustrated to scale.

List of reference numerals

| | |
|---|---|
| 1 | belt wheel |
| 2 | main body |
| 3 | rim |
| 4 | hub |
| 5 | toothing |
| 6 | tooth |
| 7 | tooth gap |
| 8 | connecting element |
| 9 | connecting element part |
| 10 | connecting element part |
| 11 | axial direction |
| 12 | height |
| 13 | surface |
| 14 | side face |
| 15 | side face |
| 16 | crown |
| 17 | recess |
| 18 | recess |
| 19 | end face |
| 20 | depth |
| 21 | depth |
| 22 | width |
| 23 | width |
| 24 | width |
| 25 | circumferential direction |
| 26 | web |
| 27 | height |
| 28 | connecting element |
| 29 | connecting element part |
| 30 | connecting element part |
| 31 | height |
| 32 | side face |
| 33 | side face |
| 34 | crown |
| 35 | width |
| 36 | recess |
| 37 | length |
| 38 | side wall |
| 39 | projection |
| 40 | loop drive |
| 41 | tensioning means |
| 42 | end face |

1. A belt wheel (1) with a main body (2), which comprises a hub (4), on which a rim (3) is arranged, wherein the rim (3) is formed by a separate component from the main body (2), which component is connected in a form-fitting and/or force-fitting manner to the main body (2) by at least one connecting element (8), wherein the connecting element (8) comprises a first and a second connecting element part (9, 10), one of which is formed on the hub (4) and one of which is formed on the rim (3), wherein the first connecting element part (9) is designed to be cam-like and the second connecting element part (10) is formed by at least one recess (17).

2. The belt wheel (1) as claimed in claim 1, wherein the second connecting element part (9) is formed by two recesses (17, 18) arranged next to one another in a circumferential direction (25), wherein the form-fitting and/or force-fitting connection can be formed with only one of the two recesses (17) and by means of the second recess (18) the rim (3) can be pushed onto the hub (4).

3. The belt wheel (1) as claimed in claim 2, wherein the second connecting element part (10) has an at least approximately W-shaped cross-section as viewed in axial direction (11).

4. The belt wheel (1) as claimed in claim 1, wherein the cam-like first connecting element part (9) is formed on the hub (4) of the main body (2) and the additional connecting element part (10) is formed in the rim (3).

5. The belt wheel (1) as claimed in claim 1, wherein in circumferential direction (25) adjoining the connecting element (8) at least one additional connecting element (28) is formed which comprises a third and a fourth connecting element part (29, 30) and with which the rim (3) is connected in a force-fitting manner to the main body (2).

6. The belt wheel (1) as claimed in claim 5, wherein the third connecting element part (29) is designed to be cam-like.

7. The belt wheel (1) as claimed in claim 5, wherein the fourth connecting element part (30) is formed by an additional recess (36), which extends in circumferential direction (25) over a greater length (37) than the width (35) of the third connecting element (29) as viewed in the same direction.

8. The belt wheel (1) as claimed in claim 7, wherein the additional recess (36) of the fourth connecting element part (30) has an at least approximately rectangular or trapezoidal cross-section as viewed in axial direction (11).

9. The belt wheel (1) as claimed in claim 7, wherein on a side wall (38) of the additional recess (36) of the fourth connecting element part (30), between the latter and the first connecting element part (9) of the first connecting element (8), as viewed in circumferential direction, the third connecting element part (29) is arranged, a projection (39) is formed projecting into the additional recess (36).

10. The belt wheel (1) as claimed in claim 5, wherein the third connecting element part (29) is formed on the hub (4) of the main body (2) and the fourth connecting element part (30) is formed in the rim (3).

11. The belt wheel (1) as claimed in claim 1, wherein a portion of the first connecting element part (9) is arranged overlapping an axial end face (42).

12. A loop drive (40) with at least two belt wheels, wherein at least one of the belt wheels is designed as a belt wheel (1) as claimed in claim 1.

13. A method for the form-fitting and/or force-fitting connection of a rim (3) to a main body (2) of a belt wheel (1), wherein on the main body (2) of the belt wheel (1) a hub (4) is formed, onto which the rim (3) is pushed, and the rim (3) is connected by at least one connecting element (8) to the main body (2), wherein the connecting element (8) is designed to have a first connecting element part (9) and a second connecting element part (10), one of which is formed on the hub (4) and one of which is formed on the rim (3), wherein the first connecting element part (9) is formed to be cam-like and the second connecting element part (10) is formed as at least one recess (17), wherein also the cam-like first connecting element part (9) is pushed into the recess (17), and wherein after this the rim (3) is rotated in circumferential direction (25), so that between the cam-like first connecting element part (9) and the second connecting element part (10) the form-fitting and/or force-fitting-connection is formed.

14. The method as claimed in claim 13, wherein the second connecting element part (10) is produced as two recesses (17, 18) arranged next to one another, wherein also the cam-like connecting element part (9) is pushed into one of the two recesses (17), wherein afterwards the rim (3) is rotated in circumferential direction (25), so that the cam-like connecting element part (9) is-moved into the second recess (18) to form the form-fitting and/or force-fitting connection.

15. The method as claimed in claim 13, wherein in circumferential direction (25) adjoining the connecting element (8) at least one additional connecting element (28) is formed with a third and a fourth connecting element part (29, 30), wherein the third connecting element part (29) is formed to be cam-like and the fourth connecting element part (30) is formed in the form of an additional recess (36) and wherein the rim (3) is connected by the additional connecting element (28) in a force-fitting manner to the main body (2) of the belt wheel (1) by rotating the rim (3) in circumferential direction (25).
